(19) United States
(12) Patent Application Publication
(10) Pub. No.: US 2021/0135602 A1
(43) Pub. Date: May 6, 2021

(54) MECHANICAL MAGNETIC ENGINE

(71) Applicant: Mohammad ALMOFADDA, Riyadh (SA)

(72) Inventor: Mohammad ALMOFADDA, Riyadh (SA)

(21) Appl. No.: 17/041,953

(22) PCT Filed: Mar. 17, 2019
(86) PCT No.: PCT/SA2019/050005

§ 371 Date: Sep. 25, 2020

(30) Foreign Application Priority Data
Mar. 26, 2018 (SA) 118390471

(51) Int. Cl. H02N 11/00

(52) U.S. Cl. CPC H02N 11/00

(57) ABSTRACT

This invention relates to a mechanical magnetic engine, which has a rewarding power. And the technical field concerned with this competencies the field of permanent and continuous self-mechanical movement, gained from clean permanent energy, non-permanent reservoirs. The most important components of this invention are: magnets, conductors, and crankshafts. Metal materials which are not affected by magnetic spectrum, magnetic materials for magnetic field. Poles and gears for turning between (horizontal and vertical, and between circular and frequency. (FIG. 1) This invention solves solar energy analyzer, mechanical fuel drills, electric motors, and the rest of the generators of clean energy such as solar energy, wind energy, hydro energy, and others. The invention can be used instead of the need for any mechanical movement energy, and any electrical energy.

### INVENTION BACKGROUND

This invention is related to movement mechanics, so we get energy, clean and attractive and permanent and continuous, without cost.

This invention is a substitute or supplement to current fuel engines: mechanical and electrical drives, which need a power source for recharging, so this invention overcomes the most problems of fossil energy, such as oil, natural gas, coal and other types, as well as motors and generators based on existing clean energy sources like solar, wind, hydro and others.

The mechanical movement and electricity needed for transportation industries and pan appliances, and others involved in the present a lot of problems, including:
1. that their sources are limited, such as oil and gas and coal types, and those that are not finite resource such as solar, wind, water currents, river, sea and so it is not without one or more of the following faults: as poor performance, or limited use, or high cost, or link to, or otherwise.
2. Environmental pollution by emission of harmful gases resulting from the combustion of materials generated for that energy.
3. The noise pollution caused by forced combustion within the internal combustion chambers.
4. The intense heat generated by combustion processes.
5. Big fuel consumption.
6. Oxygen consumption with fuel combustion result weather.
7. The high cost of fuel himself of all kinds, extracted and filtered and sorted and recycled, moved and stored, and the cost price of products.
8. High risk transport flammable materials, stored and used and pan handle.
9. Frequent breakdowns of machines that use fuel, offering its users at risk sometimes if their transport is broken down or run out of fuel in remote areas.
10. High cost for repair and maintenance of machinery that uses fuel, add to the complexity and its requirements, and the lack of specialists.
11. The need to spread reform workshops (maintenance) and need accordingly to a large number of competent engineers and professional employment, and the need for colleges and schools and teachers for education and training on the mechanics of motor fuel.

This invention will overcome with the permission of Allah almighty on those problems, or at most.

In the initial search for the nearest technical situations for this invention, and personal research, there was something of the inventions and practices soon.

### THE GENERAL DESCRIPTION OF INVENTION

This invention is based on exploiting the magnetic energy (clean) and (non-renewable), and limited cost, compared to the current situation of mechanical and electrical technology adopted on depleted and dangerous and costly energy and polluting the environment, clean energy-dependent or vulnerable Such as solar or wind, water or other types of energy or weak place of issuance and extracted as energy currents.

This invention is based on exploiting the magnetic energy (clean) and (non-renewable), and limited cost, compared to the current situation of mechanical and electrical technology adopted on depleted and dangerous and costly energy and polluting the environment, clean energy-dependent or vulnerable such as solar or wind, water or other types of energy or weak place of issuance and extracted as energy currents.

And this powerful magnetic energy invests invention clean and renewable and non-renewable, inexpensive to overcome most current technical problems.

This patent aims to shift from dependence on various sources of energy, charged or depleted or vulnerable to magnetic energy, for mechanical and electrical energy, avoiding power problems with fossil and other sources.

And this invention is huge and clean energy investment inherent in magnet, and will turn them into regular and continuous kinetic energy and rewarding by using a feature attraction and repulsion.

### A BRIEF EXPLANATION FOR GRAPHICS

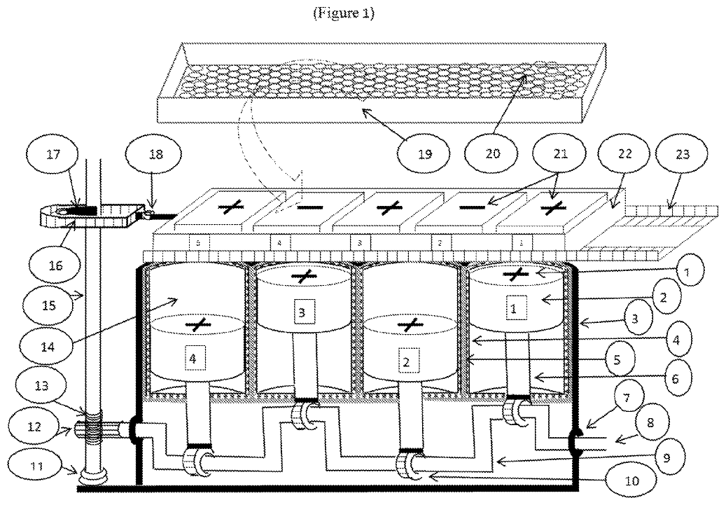

(FIG. 1): magnetic general motor composition, method of work.

Item (1): clarify swivel magnet.
Item (2): the affected magnets (responder), meaning magnet that receives force or attraction of magnets is influenced by moving up and down.
Item (3): the motor body from outside, made of selected material.
Item (4): compartments (cranks haft) from within, and is the area of vulnerability and magnetic influence, made of material that is not affected by the magnetic field as a copper or aluminum or other.
Item (5): insulating material for magnetic cute, squeezed between the body (cylinder) from the inside and the outside world about the affected magnets (effector).
Item (6): transmission leg of the magnet to the crank.
Item (7): axis passing movement across the body of the engine out of the engine.
Item (8): transmission shaft out of the motor, to the hubs car or generator or other.
Item 9: (crank).
Item (10): pass the magnet movement of crank.
Item (11): axis to install magnets movement crank.
Item (12): transmission gears of crank column to column moving magnets.
Item (13): transmission gears to a column moving magnets.
Item (14): cells in the area of vulnerability and magnetic influence between magnets affecting and affected.
Item (15): transmission crank of magnets.
Item (16): transform vertical motion to reciprocating motion.
Item (17): the emergence of reciprocating motion events.
Item (18): Joint to be accommodate movement and smooth movement frequency.
Item (19): influential magnets template cover.
Item (20): granulated (pomegranate) in the roof lid magnets, template for easier sliding.
Item (21): moving magnet, which meant going force or attraction of magnets is affected.
Item (22): template to contain magnets.
Item (23): influential magnets traffic stream.

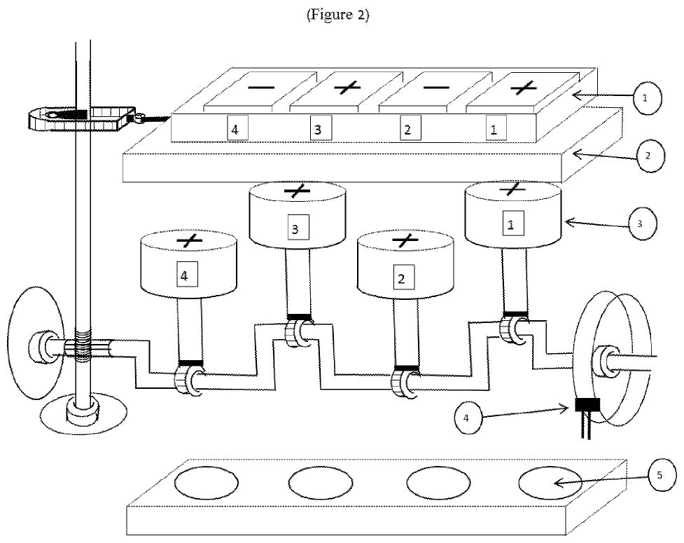

(FIG. 2): one of the many ways to create the effect of magnets affecting:

Item (1): influential magnets template.
Item (2): thermal insulation material magnetic cute template.
Item (3): the affected magnets.
Item (4): brake to stop or reduce speed.
Item (5): foam template from which the holes show that venting the magnetic spectrum.

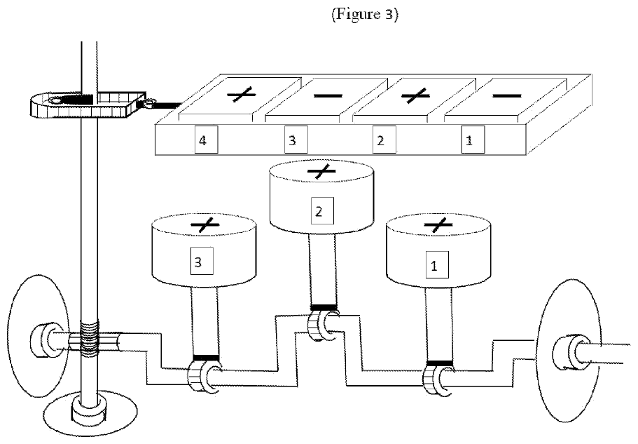

(FIG. 3): one of multiple ways to mount the motor (three of the affected magnets).

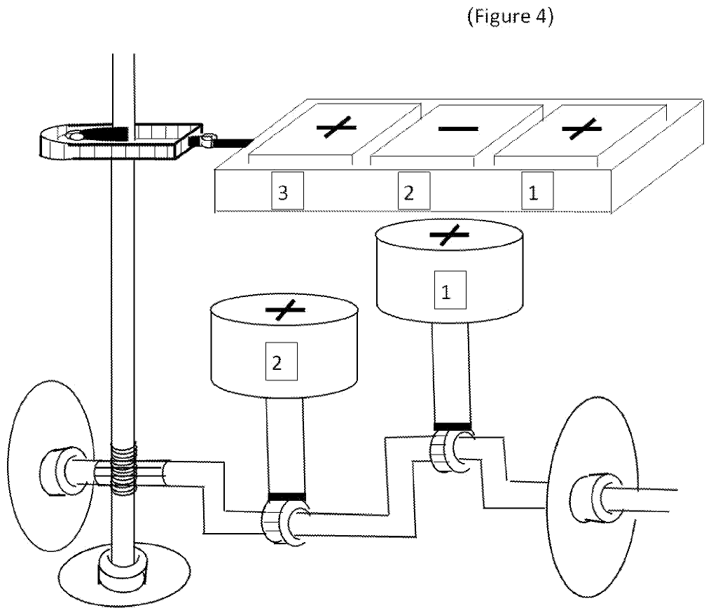

(FIG. 4): another way of multiple ways to mount the motor (two magnets are affected).

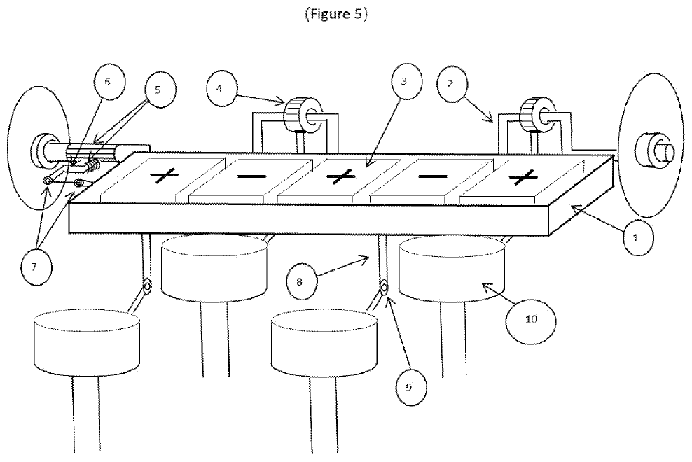

(FIG. 5): another way of multiple ways to move traffic to magnets.

Item (1): influential magnets template.
Item (2): column crank side for moving magnets.
Item (3): influential magnets.
Item (4): axis to accommodate frequency movement to movement of Karnak.
Item (5): transmission gears of crank shaft's magnets.
Item (6): a small crank shaft.
Item (7): axes to free movement and absorption bands and organized in smooth movement.
Item (8): connect the arm movement between the affected magnets and Karnak.
Item (9): axis to facilitate movement bands with the movement of Karnak.
Item (10): the affected magnets.

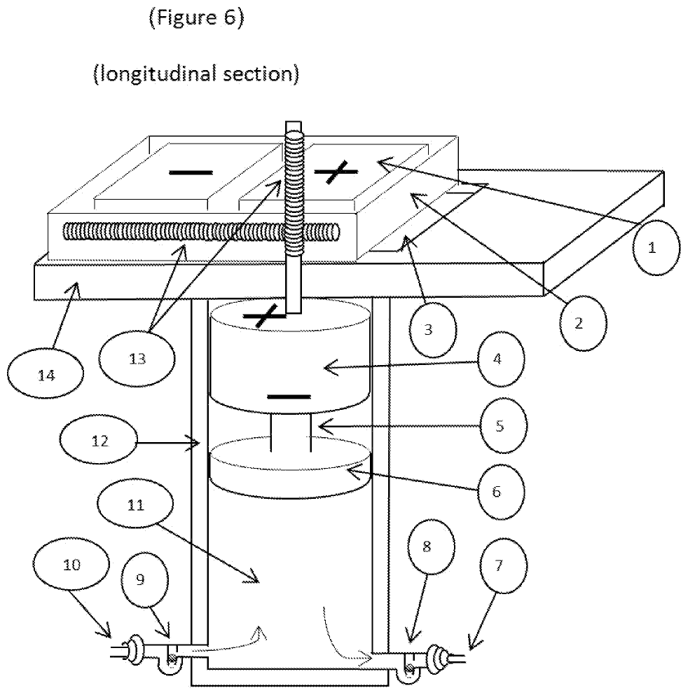

(FIG. 6): one of the multiple uses of magnetic motor: compressive strength of air or liquids or gases or other, only landing energy investment magnet is affected:

Item (1) magnets.
Item (2): template contains magnets.
Item (3): opening in the article buffer, which performs a magnetic effect.
Item (4): the affected magnets.
Item (5): connect the pole magnets affected by noise.
Item (6): noise pressure.
Item (7): compressed air gas liquids: article.
Item (8): valve allows the compressed material exit, entry is not permitted.
Item (9): valve allows entry and exit is not allowed.
Item (10): compressed air gas liquids: article.
Item (11): cubicle material to be compressed.
Item 12: internal magnetic cute proofed material.
Item (13): gears convert motion from vertical to horizontal reciprocating.
Item (14): insulating material for magnetic cute.

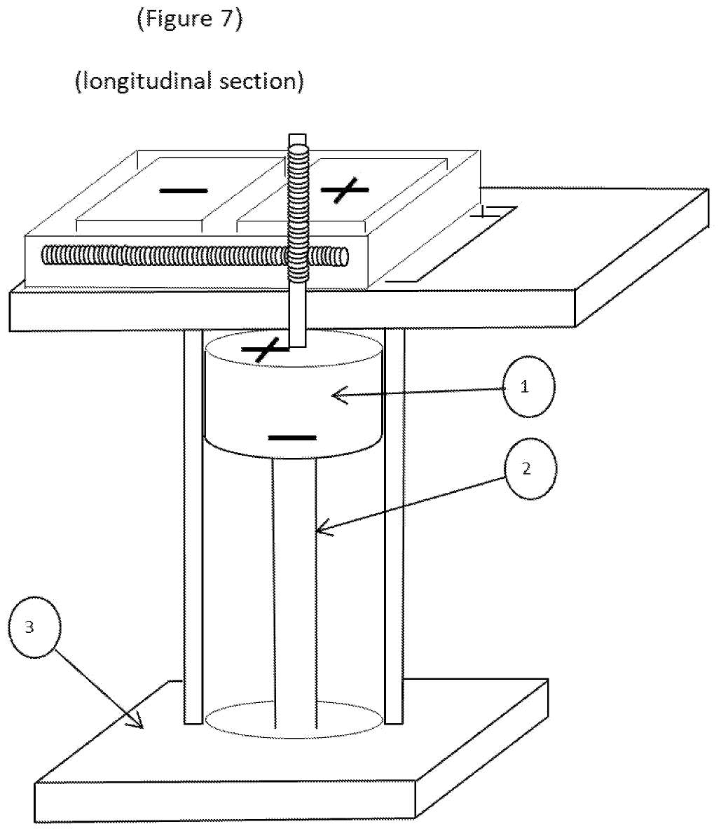

(FIG. 7): one of the multiple uses of magnetic motor: reciprocating and seismic capacity squeeze compressor:

Item (1): the affected magnets.
Item (2): connect the column movement affected compression base magnet.
Item (3): compression base vibration.

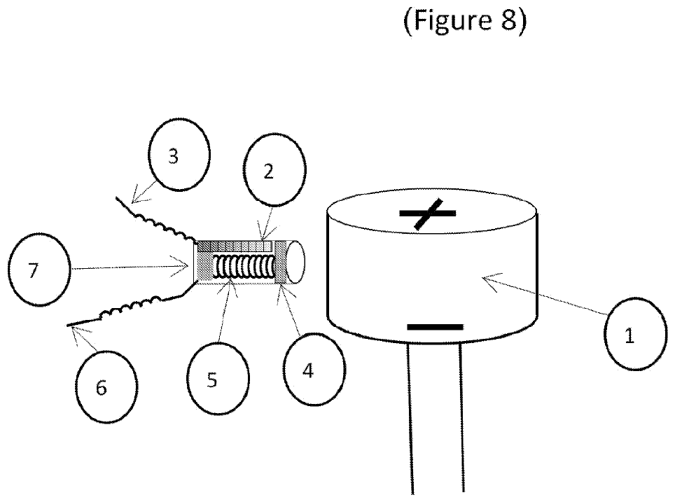

(FIG. 8): sensor (sensitive) to measure the ability of a magnet:

Item (1): working magnet; both impressiveness or affected.
Item (2): key graded electrical circuit.
Item (3): pole circuit warning lamp connector on the display.
Item (4): copper piece deterrent for the spring compressor.
Item (5): a copper spiral spring.
Item (6): pole electric circuit electric battery connector.
Item (7): iron piece snap affected by the strength of the magnet.

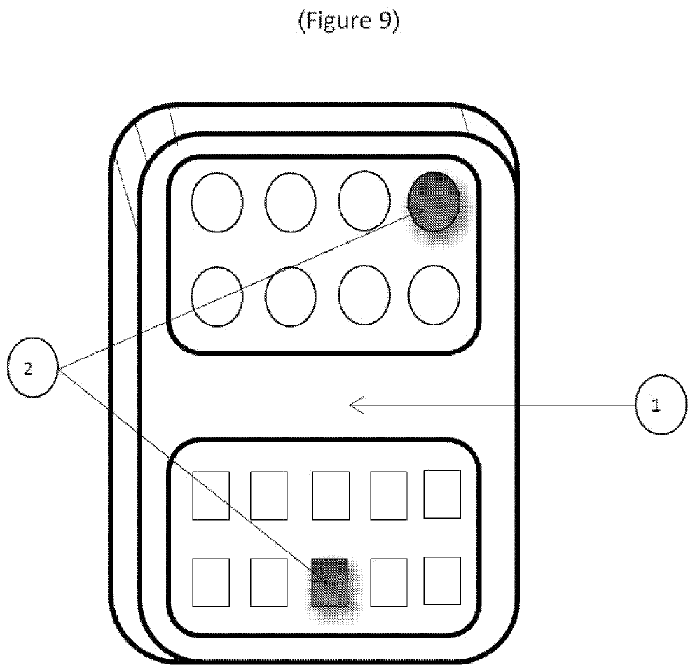

(FIG. 9): give the permanent and continuous reading to measure magnetic field strength in each magnet:

Item (1): display.
Item (2): warning lights step how magnetic capacity in each magnet.

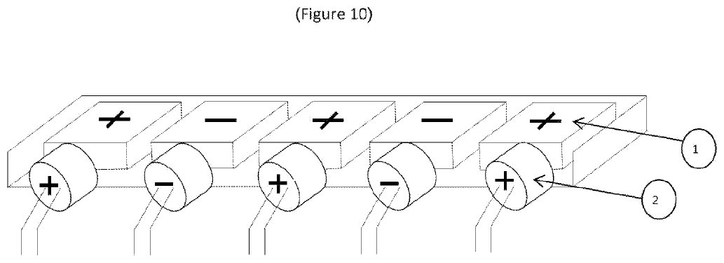

(FIG. 10): one of the many ways to ship magnets affecting:

Item (1): moving magnet.
Item (2): moving magnet charger.
Item (3): connect the arm motion of the crank to the magnet charger.

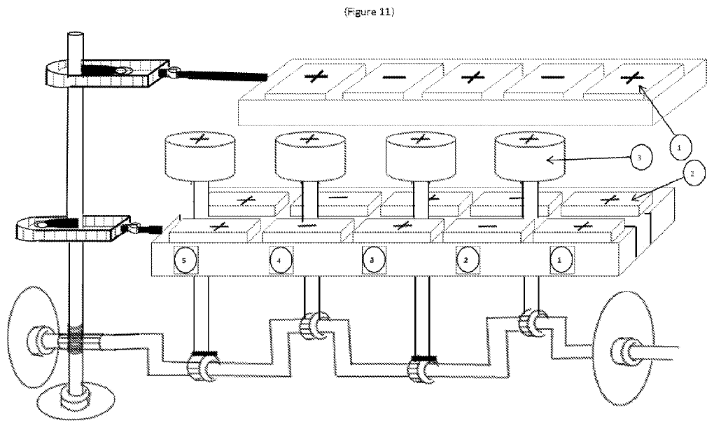

(FIG. 11): one of multiple ways to double the energy extracted from magnets:

Item (1): magnet top influencer.
Item (2): moving magnet.
Item (3): the affected magnets.

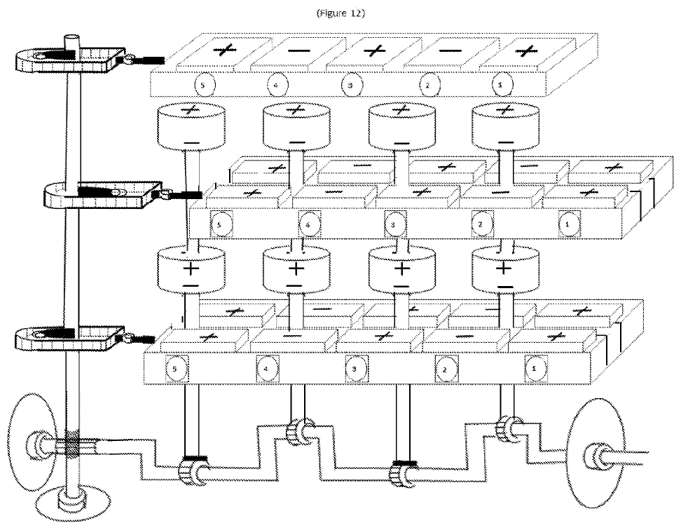

(FIG. 12): another way of multiple ways to double the energy extracted from the magnets.

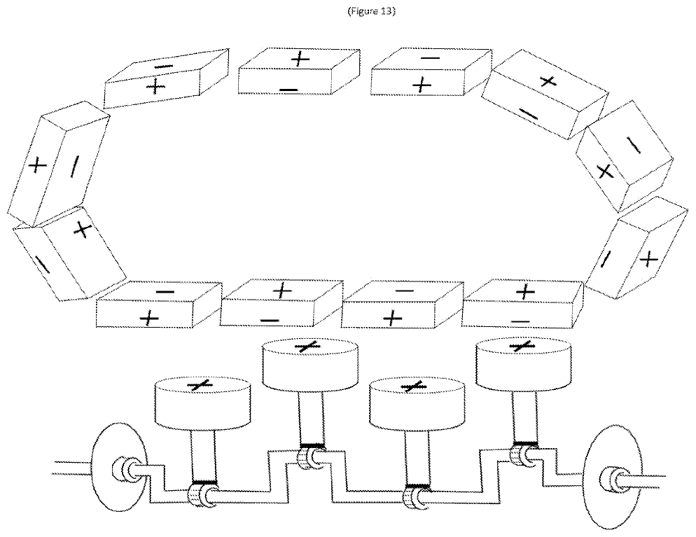

(FIG. 13): one of multiple ways to perform influential work of magnets.

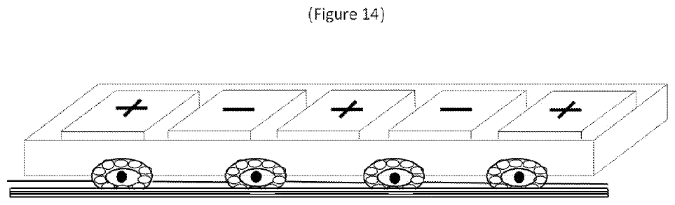

(FIG. 14): one of multiple ways to facilitate the movement of magnets and magnetic spectrum mitigation.

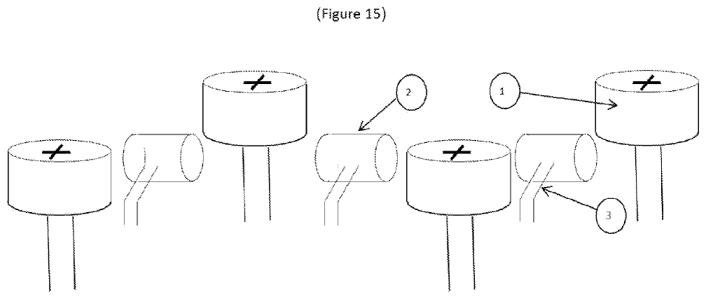

(FIG. 15): one of the many ways to ship magnets are affected:

Item (1): the affected magnets.
Item (2): magnet charger.
Item (3): connect the arm motion of the crank.

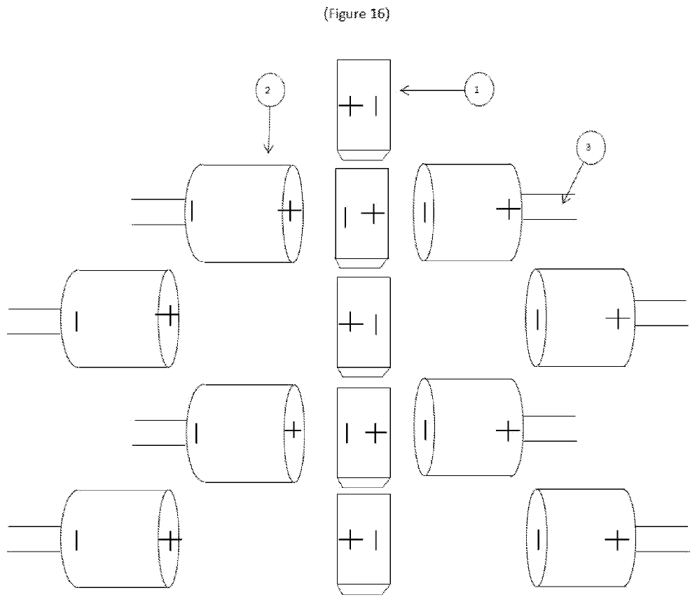

(FIG. 16): the combined effect of two magnets per magnet succumbed.

Item (1): moving magnet.
Item (2): the affected magnets.
Item (3): connect the arm motion of the crank.

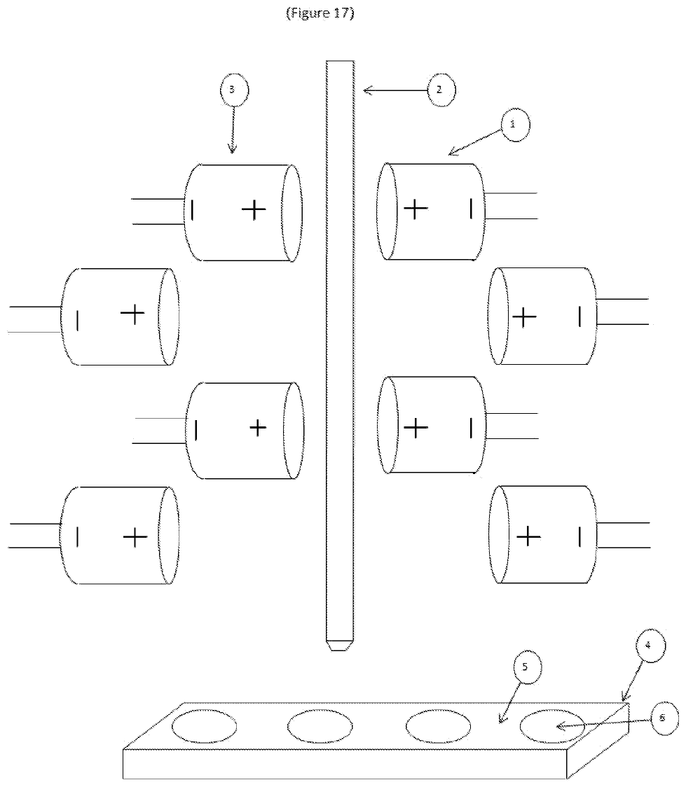

(FIG. 17) work affected some magnets in some incoherency card only.

Item (1): moving magnet is affected at the same time.
Item (2): blocking template in position.
Item (3): moving magnet is affected at the same time.
Item (4): a cross section of a template, cloaking the holes leading to the entry into force of the magnetic spectrum.
Item (5): solid area of blocking template.
Item (6): the openings and the holes leading to the entry into force of the magnetic spectrum.

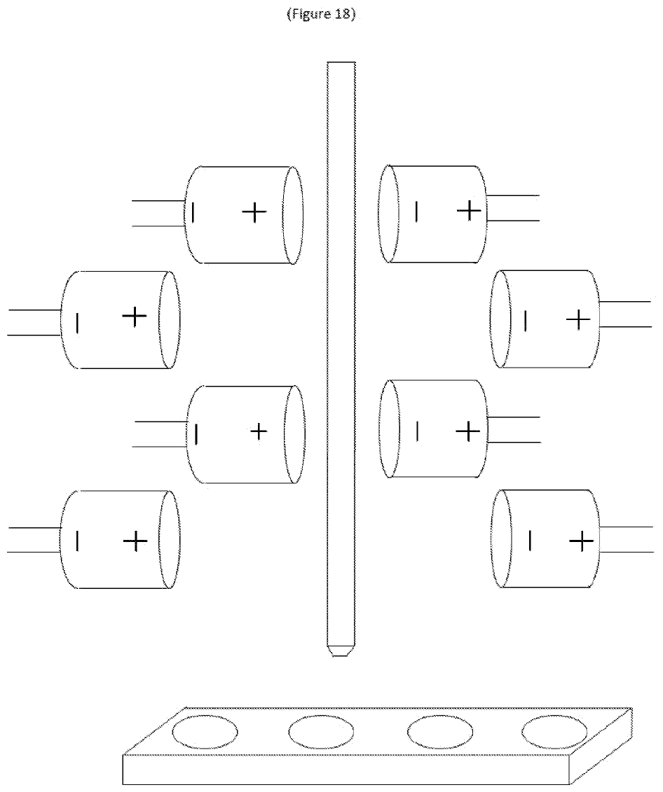

(FIG. 18): the affected magnets work together in some chemistry card only.

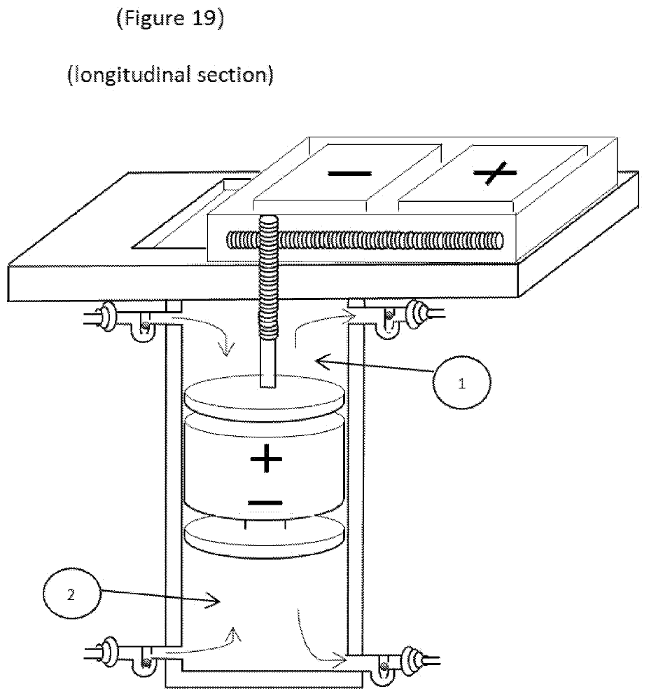

(FIG. 19): one of the multiple uses of magnetic motor: compressive strength of air or liquids or gases or other investing my energy ups and downs of magnets is affected:

Item (1): upper compartment for collecting material to be compressed.
Item (2): lower compartment for collecting material to be compressed.

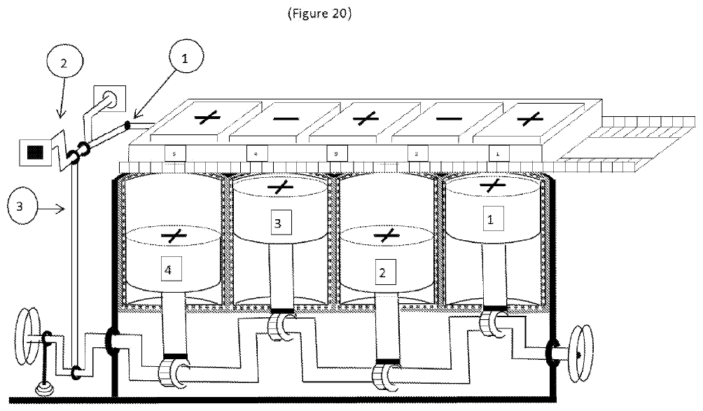

(FIG. 20): transmission of crank magnets affecting template across top and crank column:

Item (1): axis to facilitate frequency movement to movement of crank.
Item 2: rules for installing the crank in the engine body.
Item (3): a small crank shaft.
Item (4): connect the arm movement between crank and crank.
Item (5): hate to turn the engine power and configured for multiple uses.

### DETAILED DESCRIPTION

This mechanical motor magnetic field like fuel engines (internal-combustion machine), we replace the fuel mixture exploding oxygen in cells assigned him.

Replace broken up and burned the ability of permanent magnet (gravitational and the conflicting), the desired impact here depends on several elements, including: exposure to magnetic attraction, nice and antagonism, cloaking him between magnets, to add an element of surprise and surprise in those processes.

Pressing capacity fuel engines that turn into reciprocating movement, would be the same capacity of attraction and repulsion magnetic engine.

This capability is investing it into circular motion; vertical or horizontal (FIG. 1), through the crank shaft (9 form 1).

Survival can be vertical or horizontal reciprocating motion, as the case may be, to use:
Capacity of compressor for air or liquids or gases such as air conditioning and refrigeration gas (Freon) or other (FIG. 6).
The capacity or seismic capacity of kicking or stamping and pressing, as the bullets for asphalt, soil, and other pavement materials, etc. And block and brick factories and prefabricated concrete slabs, cut metal, plastic, paper, etc. (FIG. 7). And other appropriate uses of reciprocating motion.

Gets the updated movement influence investment attraction and repulsion between magnets including magnets call: (affected) or (effectors) (2 form 1) with the same places (seals and spare parts availability) fuel engines, and number commensurate with the required capacity, either one (FIGS. 6) and (7) and (FIG. 19),

Or two in a row (FIG. 4) or two facing pages, or three in a row (FIG. 3), or four in a row (FIG. 1) or two facing pages, or four opposite points, or five in a row, six in a row, or two facing pages, or eight in a row,

Or two facing pages, or four opposite points, or ten in two facing pages, or twelve in two facing pages, or four opposite points, or more than that number, depending on the capacity required, in any appropriate manner in the way the lineup and way meet.

And sttasr each opposite rows of magnets are affected, in several ways, including:
1. the influence of two influential arranged occurs, each of them in the hand, one magnet is affected, and the other on the other side the corresponding magnet expelled at the same time per session to crank, and one Reef that are affected magnets. Share of crank.
2. Like the previous method but gets attraction or the package at the same time between magnets and influencers and magnets and affected, during the session of the crank, and have each of the affected magnets and dissuade him from crank meets a corresponding to magnet idolatry.
3. We could double capacity four times with double magnets, so the top and bottom on each opposite, one magnet is affected, and then threw him out at the same time, other side, per session to crank
4—Double capacity eight times if two affected magnets at each opposite, actually each players, one that attracts, and then expelled.

So multiply the capacity by the number of the affected magnets per row, or opposing grades, that match her movement in crank, or adjacent rows, as influential magnets sites: on one side or two sides opposite each magnet is affected.

Breeding intended to stick together among themselves to double capacity in one session traffic.

The number is subject to multiple geometric considerations and considerations of much needed energy.

And select ability magnets, size and weight as needed for the power required.

Be influential in repulsion or attraction row of magnets affecting (21 FIG. 1) reward on top of each row of the affected magnets (effectors) (2 form 1), to be the power incident resulting from the attraction and repulsion between the poles of magnets.

The Exchange reaction between magnets affecting (21 FIG. 1) and the affected magnets (2 form 1) be installed magnets affecting template (19, 22, FIG. 1), each of which corresponds to a magnet of the affected magnets', Placed on the same order of movement of the affected magnets (FIG. 1) and make one influential chemistry pole magnets with affected by magnets on a pole so jarring. Any positive and then negative, then positive and then negative, then positive, for example. And so on. While the order affected uniformly, magnets are all on the negative pole, or on the positive pole (2, FIG. 1), you can reverse the polarity between the affected magnets and Magnetics.

And the more we use types of magnets are distinguished from other such power magnets (neodymium) (Neodymium). Workings of the influential magnets:

Influential magnets work in several ways, including:
1. To be fixed, and their effect on the magnets that are affected by sudden availability and cloaking materials known as cloaking.
2. to be animated to anyone, either forward and backward, either to one of the sides' to both sides, either by the height and land away and near, either to other types of movement.

Methods of Drawing Motion to Magnets and Blocking Template:
1. The best sourcing of crank (9 FIG. 1) that can propagate the movement in several ways, including the following:
A—turn part of the crank vertical creases reciprocating movement (9 form 1) to reciprocating motion through a small crank shaft accidental (2 FIG. 20) connects between the arm (3 FIG. 20), it's better this way, because they convey motion to magnets affecting directly, without further need for joints and transitions, or arms Sides, or other routes.
B—Chain and sprockets and small crank at the top.
C—transfer part of the crank column horizontal circular motion into vertical circular motion, through the gears (12 FIG. 1) at the end of crank, perpendicular with the crank (15 FIG. 1) equipped with gears (13 FIG. 1), then turning the vertical circular movement to horizontal reciprocating movement, many best ways through the hook tip of the crank, or Find a bump and the emergence in this crank (17 FIG. 1), and in this way twice; that friction gears spin the crank Petros vertical Oud-corrosive weakness are rapid and hitless.

This method is better than converting those vertical circular motion to circular motion transverse horizontal again and then converted to reciprocating motion because it will need to add detail until we reach out to move the magnets.

And even this way better than converted to longitudinal horizontal circular motion, it will need more processors to align with requirements of reciprocating movement longitudinal.
2. derive the movement of the affected magnets (10 FIG. 5) directly through the arms (8 FIG. 5) installed in each one, each one equipped with pivot hinge (9 FIG. 5) to facilitate movement, all linked by a small additional crank shaft (2 FIG. 5), equipped with pivot hinge (4 form 5) to facilitate movement, There will be horizontal movement used to move the template (1 FIG. 5) moving magnets (3 form 5), through the gears in the parties (5 FIG. 5), or a small crank column, as described in the previous method, and then turn the movement by a small crank (6 FIG. 5) reciprocating movement longitudinal movement is slipping through the joints (7 FIG. 5) call tactful Core magnets.

All these roads and other reciprocating movement events intended in influential magnets (22 FIG. 1) that can be put in a template move the bandwidth (16 form 1), as well as influential magnets, if used (FIG. 11), and influential medium magnets, if used, and each level Multiple levels of the affected magnets listed (FIG. 12) when using this method. And move the template via a flexible link (18 form 1) to accommodate selected movement, whether movement or motion jutting promontory, bands, and regulated the movement smooth.

And can provide the crank or more per session to exploit events in two or more frequency.

This can be fixed, or be mobile mechanical stand out and belong to Cummins again.

Ways of influencing the magnets effect affected magnets:

There are too many ways to cause this effect, and I shall confine myself to display the number, vary in importance and usefulness:

The first way: put magnets affecting template (22 FIG. 1) moves into the bloodstream (23 FIG. 1) forward and backward movement on a regular frequency commensurate with the movement of the affected magnets

(Reporting), and the number of influential magnets plus a number one affected magnets for alternating between attraction and expulsion.

Method 2: to be influential magnets (1 2) fixed, and the same number of affected magnets (3 2), reciprocating movement limited to blocking template (2 form 2) made of dielectric and magnetic nice blackout, to prevent the magnetic spectrum of influence beyond this template, like a substance (Teflon), substance (Graphite), (Bismuth) or other insulating materials which might be discovered or developed.

It is well known that these materials vary in strength of insulation, used what fits every situation.

The rise of any affected magnets adapted case cover template cloaking for moving magnet's magnetic field, and then shifts when cloaking template affected magnet higher points, to occur a sudden shock wave and magnetic influence when peak; the best point of convergence, foam cut the magnetic field between the magnets and the affected magnets at appropriate times, then drift away in time also to occur across the voids (5 FIG. 2) from the sudden onset and magnetic influence.

Magnetic Field and Isolating Events Ways Blocking:

It could happen; stay away and get closer to front and back, left and right or up and down.

It can happen with cloaking, insulation, and have several ways, including: all move, forward and backward, right and left, or to one side, and either moving fragmented into pieces, each piece of which is complete, move the magnet is affected, or consist of two pieces spread out like a normal door panes, or The cloud door panes, left and right or forward and backward, and this may overlap with adjacent half, this faster movement.

This second method is easier for several reasons, including:

1. The buffer class will be lighter than a movement influential magnets; because getting rid of resistance that hinder part of the movement, and consume part of engine power, in this way no resistance and liberated full engine power.

2. This will provide effective magnet in excess of the number of magnets that are affected, their number only.

But this method is less efficient than the first way that gives double capacity, the coping in all affected magnets per session: dissonance, followed immediately by the next moving magnet attraction capacity pending the return of the affected magnets.

In this case it will be relying on a potential only, with other disabled, which reduces efficiency to almost half.

This method is used in all cases: either if you use the affected magnets in a row, or multiple rows, as used with magnets affecting only the top (FIG. 1), or at the top and bottom (FIG. 11), or at the top and bottom, middle, or if used with the affected magnets Multi listed (FIG. 12), Or if you use a template that magnets affect halfway between adjacent rows of magnets affected (FIG. 16).

Method 3: make magnets affecting one rows equivalent (1 FIG. 11), and the other at the bottom (2 form 11) at the end of the movement of the affected magnets (3, FIG. 11), moving back and forth in harmony with the movement of the affected magnets to be the power output of each affected magnets Supported on the repulsion of magnets the top row, on the attraction of magnets in the bottom row, to get traction and power at the same time expelled the affected magnets (3, FIG. 11), so each magnet is impressed with the strength of one attraction and repulsion from the other side at the same time, this will make energy The incident is very high.

Method 4: placing magnets affecting two layers (Doreen) or more than two layers—by arm's length affected magnet depth walks crank—be in successive rotation movement, to keep the affected magnets if direct exposure sustained affected by magnets affecting layers Various'

Works the same way as magnets affecting both upper and lower, each affected continuous traction magnets, the power of expulsion, and to keep the force of attraction and force the same used in all stages of the cycle of the magnet.

Method 5: like the previous method (fourth), but listing the number of affected magnets as needed (FIG. 12) between each other and sufficient space for movement, magnets and moving magnets templates affect its course, as in the first method, forward and backward motion of reciprocating The regular movement of the affected magnets.

And the number of influential magnets plus a number one affected magnets for alternating between attraction and package, in which case each magnet is two effect processes simultaneously; one attraction between the negative pole and the pole of a magnet affected upper positive, dissonance Among the positive pole and the pole of a magnet affected bottom of it positive, and so on. Between each level of the affected magnets.

And you can install each level of magnets and rely on movement events affected cloaking process magnets

Diversification can also between methods as appropriate and needed.

Method 6: turn face magnets affecting between negative and positive, by movement of the affected magnets.

But this method is slower than the sliding method, and magnetic nice exposure opportunity hijackers would be ineligible.

Method 7: move the template of magnets affecting all in its circular motion, similar to track movement (FIG. 13).

This method is quick, but its flaws need to prepare multiple of magnets, and need more room.

Method 8: move template magnets affecting all into reciprocating movement forward and backward the same way regular first, but be influential magnets template in the middle between two rows of magnets affected (FIG. 16), which occurs every magnet in two magnets are affected in Same time; they talked with them or antagonism, we invest per transaction of all magnets in the impact two magnets are affected two one right and one left. Or one on top and one below it, it is well known that the efficiency of the magnet pole is not affected by the other pole is busy with chemistry or another mismatch.

And this way we will produce two mechanized in two at a time, like two each independent of the other. Each investment can be individually in separate service can collect potential in one capacity.

Method 9: like the previous method (8) completely, but without the magnets, but the effect of magnets that are affected in some (1, 3, 17) attraction and antagonism, and the effect is dependent on the blocking one of the methods mentioned earlier in the paragraph: ‘ways of effecting its magnetic isolation And blocking’, to move a template block (2, 4, FIG. 17) forward and aft,

Current solid zone blocking (5 FIG. 17) for blockbuster-minded poles on each other, so that there will not be a hindrance to movement, and when he approached the meet shifts curtain over the holes in the block template (6 FIG. 17) in front of the magnetic field of magnets and eagles (1, 3, 17), until it happens. Disharmony at the peak. Or the process in reverse; that rely on cloaking all different from each other poles also glorify his praises (FIG. 18), even if you reached the end spacing horrid cloaking of chemistry occurs. And so on. And chemistry might be weaker than adoption.

This method is less efficient than the way her manners before her (8) by almost half.

And the roads leading to too many impact events and unlimited, and was limited to the most important ones.

Insulation can be dispensed with and blocking of magnetic nice to get the affected magnets apart, perhaps resulting in the independence of each magnet is impressed with his affairs as influential for each allocate two magnets magnet untouched, one of attraction, followed by the other to expulsion, the movement sequence.

And displacement and movement for the cloaking could be limited to active magnets or only limited to blocking template only, or both.

Preferably take account of shortening affected magnets leg shortening creases crank with it because that will reduce a distance not to, because the distance between the magnets, and if affected weak influence attraction package.

In order to return the affected magnets for his place after a wave of repulsion (in cases of Pistons compressors and more) can use magnetic attraction, as in previous cases, you can use

Vibrant spring return as means for example (click) or compressed air or liquid or gas, or other, in these cases we'll lose part of the capacity they're spring pressure spring (click) or air or liquid or gas, or other (like tipper piston fuel engine that returns in the second session to press further C fuel and air) so using magnetic power is best to return the affected magnets to place, with the possibility of investing in new capacity events return to another use, it could be withdrawn or another pressure on the other side of the hatch (1 FIG. 19) along with the same function in the cell Basic (2 FIG. 19).

### CONCLUSION: THE WAYS IN WHICH THE MECHANICAL CAPABILITY OF MANY MAGNETS EVENTS, INCLUDING

First: only one parcel force, touching only one constant magnets, each magnet is affected, during the rise of the affected magnets and decline (FIG. 2), with the use of magnetic separation or spacing.

Second: only one attraction of a magnet only one hard touching, each magnet is affected, during the rise of the affected magnets and decline (FIG. 2), with the use of magnetic separation or spacing.

Third: the power of attraction and power of expulsion (or vice versa) of two magnets, taking turns in a moving, effective (FIG. 1) during the rise of the affected magnets and getting off.

Fourth: power of expulsion of one other parcel force, followed by the other side, fixed magnets, one in the hand and the other on the other side, with the use of isolating or spacing.

Fifth: the power of attraction of one other attraction, followed by the other side, fixed magnets, one in the hand and the other on the other side, with the use of isolating or spacing.

Sixth: power of attraction and the power of expulsion, during the rise of all affected magnets and just disintegrated, mobile players, arranged to take turns in the hand, and represented them on the other side, where the affected magnets for traction on the one hand, and the power to expel from the other during ascent, and reversible during Landing (FIG. 11).

Seventh: same way as the previous but with double magnets affecting and affected (FIG. 12).

eighth: put magnets affecting template moves across the back and forth motion of reciprocating, between two rows of magnets affected (FIG. 16), which occurs every magnet in two magnets succumbed two talked with them at the same time; or antagonism.

Nineth: like the previous method perfectly, but without the magnets, but the effect of magnets that are affected in some antagonism (1, 3, 17) or affinity (FIG. 18), and the effect is dependent on cloaking or spacing, etc.

As I mentioned earlier, the means and influence among too many magnets and unconfined, it reported only models.

How to Maintain Power from Magnets:

Magnets, magnets are affected will face fierce resistance and severely, she can't work with him easily, because the surrounding material and handle spectrum magnetic adhesion, as iron.

To overcome this problem, there are many ways to get rid of this problem, for example:
1. To make the engine body and all materials not affected by the magnetic field, such as copper or aluminum or reinforced plastic or other similar materials.
2. Such pieces of iron, but uses the insulating material of the magnetic field between the magnets and the thickness is sufficient to bring about the total isolation. There are many insulating materials, which can be enclosed magnets. Insulation can be for magnetic components inside cute magnets when manufacturing, covering those neglected ones, that if this method did not cause any obstruction such as unable to recharge the magnet or impeding his movement.
3. Armature one way diverge magnets apart sufficient distance which magnetic spectrum effect fades.

And influential magnets also will face stiff resistance from another type, due to strong pressure upon the jarring Confluence poles defiant; negative with negative, or positive with positive. And drag force acquired at the instigation of convergence of different poles; negative with positive, and this causes friction when we choose that magnets affecting mobile, and this would give rise to friction several problematic, including:

1. The weight, and then the movement of the engine and part of the energy loss.

2. Eat objects subjected to friction, with length of use.

3. Generate intense heat.

There are several ways to get rid of friction and resistance, or mitigation, such as:

1. Permanent lubrication of friction pivots.

2. facilitate the sliding block magnets, if run on Rails, fast template on Roman Yes (FIG. 14), or wedging granules Roman Yes (20 FIG. 1) between the mobile template (FIG. 22) and hard lid (19 FIG. 1) this material is vulnerable to magnetic field

Like copper, for example, or cutting the influence of magnetic field by the aforementioned means or other means.

Like copper, for example, or cutting the influence of magnetic field by the aforementioned means or other means.

Magnetic capacity may be weakened or lost on impact and beaten, or high heat, or otherwise, in order to discover the weak magnet or the loss of capacity, installing sensors (sensors) on each magnet, and either be mechanical (FIG. 8) or electric or electronic, or other means Leading up to the end, to give permanent and continuous reading to measure magnetic field strength in all magnets,

And be reading this in a separate screen (FIG. 9) put in place command and control; in vehicles or machinery or other, gives all their sensitive traffic light color gradient, or signal light of one color graded strength, or graded blinking or beep gradient force, or otherwise accruing to the purpose of the light signal, if I started being able to decrease and then increase with increasing decline, or vice versa, start strong start with low capacity, and then go down the gradient with lower capacity.

The aim of this is to replace the weak magnet or returned shipment, or magnet charger runs (10) and (FIG. 15). Delicate can determine approximate default operational life remaining for any magnet, by the ratio between the lost energy and uptime in natural conditions and circumstances.

Delicate or mechanical sensor contains several pieces and can be manufactured in several pictures, including: putting an iron piece (7 FIG. 8) or acts as iron, installed in the spiral spring (5 FIG. 8), deterred by the front piece of copper or brass Loco (4 form 8) affected by delays and progress rail piece cute magnets Working (1 8)), According to the strength of the magnet and his weakness, retreating or advancing by, giving read to put magnets by electric circuit connected between two poles (3, 6, 8) by Rod graded (2 form 8) or equivalent to calling the current in the lamp (2, FIG. 9) for this magnet in display (1, FIG. 9).

Recharge Method and Magnetization:

Magnetic motor installation is required in such a way as to allow shipment of magnets or replaced easily, when diluted in any influential magnets or magnetized untouched, for any reason, up to a certain level, the standard sensor (FIG. 8) for this alert signal magnet at the display (FIG. 9) to unscrew it and ship it outside the engine, or Gives a special charger for this magnet to work, and when the magnet to fully charge (saturation) extinguished the signal of the display for this magnet, and gives the command to its charger, and it may be appropriate to continue working during the Chargers run so be charging magnets Continuously during operation, if necessary, and there was no harm, then there is no need to connect the charger with sensors, and keep working sensors to detect damaged magnets or shipping for any reason.

Chargers can be influential magnets (2, FIG. 10), approaching the influential magnets (1 FIG. 10), so seek friction and crushing during go, or return, as poles of magnets, as well as the work of truck magnets (2 FIG. 15) with the affected magnets (1, FIG. 15); Approach her to seek and friction during the ascent, you walk away during landing, or just the opposite poles of magnets, and be connected to the crank shaft by tentacles (3, FIG. 15) or other means for the purpose.

Or uses the electric file, either by intermittent stream; works when one of the two movements, and cuts off when the others, or always works but switches between Poles, for shipping during the movements together in each magnet or other multimedia

One charger could that ships from both sides to move the charger right and left here and there for shipping each magnet untouched during his way up and down, and can ship them together at one time; while this rise and fall at the same time, the first affected if magnet climb.

The second case, the affected magnets getting off, then veers, capsizes, or come down with cloaking material for obscure and open respectively. Or other, to lead the Mission in reverse, or uses an electric charger, be the change through exchange between positive and negative poles, or other suitable means, and they are many.

And like it says in the reloading magnets.

There will be a requirement to open shops and places to recharge and alter magnets (more like cooking gas cylinders switch stores), have to reset the magnetization externally, any weak magnet decoder or wastage of energy, road and ship mentioned earlier. Magnets can be shipped, a number of various capacities and sizes, in preparation for immediate switch places.

Start, Stop, and Control the Speed:

You can control the speed and to slow down and stop if we needed it, or when the fear of increased and its dispersion of control, coercive, or either the eyebrow to the magnetic field, either. He proposed the following three means are preferable:

1. block the magnetic field (2, 5, 2) at once or gradually, until the engine stops completely himself momentarily. Or withhold the staging area when will reduce the speed until you reach the desired speed, then when you run will again displaced cloaking gradually to start magnets interact and work and move automatically, and then continue to shift gradually cloaking until the engine speed.

2. Dampen the motor gradually (4 form 2), in the same way as the car brakes, low speed gradually to the required speed, or even stop. When operating the accelerator or the brake is free will.

3. Moving magnets from the spacing effect in the affected magnets gradually, as needed.

It can be used to start a startup device movement: (Starter) when needed.

Engine Cooling:

Engine cooling process may need to air or water or other magnets as centrifugal force, when there is direct contact, so you won't get the magnets to the weakness or loss of strength in the College, the magnet could weaken his power or lose it altogether to several factors, including exposure to high heat, the effect of the degree Depending on the type of magnet.

The engine includes supplementary requirements, improvement, such as extras:

1. Engine oil container when you need to use oil.

2. Oil pump, to lift oil to areas of friction, in order to facilitate slipping and reduce friction, and assist in cooling.

3. Push the water pump interspersed between magnets for cooling.

4. Year cover for motor, or top cover, as the case may be.

5. as appropriate, water cooler (Radiator), Freon compressor and adjustment (dynamo for generating electricity) and other basic or supplementary requirements as needed.

1- Mechanical engine based on magnetic resonance or magnetism or depends on them together to induce continuous mechanical movement.

2- A way to generate continuous energy by attraction and magnetic resonance

3- Sensors to detect the magnet energy, and detect the weakness or depletion

4- way to charge the magnet and re-energize it, inside the engine during work, movement and operation, friction, or electricity, or both

5- Spare parts related to this invention

6- Element exposure to the magnetic spectrum and blocking it between the magnets, rotating them in it

7- Element of surprise and surprise wave magnetic effect, between magnets, to generate energy

8- Drive fuel engines and convert them into magnetic engines.
